(19) United States
(12) Patent Application Publication
(10) Pub. No.: US 2009/0145347 A1
(43) Pub. Date: Jun. 11, 2009

(54) INDICATION MEMBER

(75) Inventors: Mitsutoshi NAKAMURA, Tokyo (JP); Tatsuya NAGASE, Tokyo (JP); Motoi NISHIMURA, Tokyo (JP); Aya SHIRAI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/326,366

(22) Filed: Dec. 2, 2008

(30) Foreign Application Priority Data
Dec. 10, 2007 (JP) 2007318085

(51) Int. Cl. G01K 1/02

(52) U.S. Cl. 116/216

(57) ABSTRACT

An indication member having an original structural color, is provided with an indication layer to cause a structural color change irreversibly by receiving a stimulus from the outside so as to exhibit another structural color different from the original structural color. The another structural color obtained by the structural color change is not reversed to the original structural color.

### CROSS-REFERENCE TO RELATED APPLICATION

This application is based on Japanese Patent Application No. 2007-318085 filed on Dec. 10, 2007, in Japanese Patent Office, the entire content of which is hereby incorporated by reference.

### BACKGROUND OF THE INVENTION

The present invention relates to indication members which change a structural color by receiving a stimulus (hereafter, referred to “an external stimulus”) from the outside, fix the structural color after the changing and maintain the changed structural color so that the indication members can be used as, for example, sensors such as a sensor to detect an environmental fluctuation, a display, a panel, a sheet, labels such as a prevention label for an unauthorized seal-opening, and so on.

As indication members utilizing the characteristics of a structural color, conventionally disclosed are indication members (refer to Patent document 1) which do not change their structures and indication members (refer to Patent documents 2 and 3) which employ an elastic member and change a structural color reversibly at the time of receiving a stimulus from the outside.

However, in a structural color change disclosed by Patent documents 2 and 3, the changed structural color in response to a stimulus from the outside is not maintained and fixed. Therefore, for example, in the case that the indication members are used as a sensor, there is a problem that the history of the structural color change cannot be noticed if a user does not attend at the Lime of detecting the stimulus. Further, in the case that the indication members are used as a display or a panel so as to display an image continuously, there is a problem that it is necessary to apply a stimulus from the outside continuously so that a lot of energy is required.

On the other hand, as a technique to detect “turn per evident” and “unauthorized seal-opening”, there is a technique to detect the history of seal-opening by the structure in which an original image and character are changed by the seal-opening and the changed image and character are maintained and fixed (for example, refer Patent documents 4 and 5).

However, these image change and character change are not distinctive. Therefore, this technique lacks practicality.

Patent document 1: Japanese Patent Unexamined Publication No. 2004-276492 (official gazette)

Patent document 2: Japanese Patent Unexamined Publication No. 2004-27195 (Official gazette)

Patent document 3: Japanese Patent Unexamined Publication No. 2006-28202 (Official gazette)

Patent document 4: Japanese Patent Unexamined Publication No. 2001-301799 (Official gazette)

Patent document 5: Japanese Patent Unexamined Publication No. 2002-82616 (Official gazette)

### SUMMARY OF THE INVENTION

The present invention has been achieved in consideration of the above circumstances. An object of the present invention is to provide an indication member in which an exhibited structural color is changed irreversibly in response to an external stimulus and the changed structural color is maintained.

An indication member of the present invention comprises an indication layer to exhibit a structural color, causes an irreversible structural color change by receiving a stimulus from the outside, and maintains the structural color obtained by the structural color change.

### BRIEF DESCRIPTION OF THE DRAWING

FIG. 1 is an explanatory sectional view showing schematically one example of a structure of an indication layer constituting an indication member of the present invention.

FIG. 2 is an explanatory sectional view showing schematically another example of a structure of an indication member of the present invention.

FIG. 3 is an explanatory sectional view showing schematically another example of a structure of an indication layer constituting an indication member of the present invention.

FIG. 4 is an explanatory sectional view showing schematically still another example of a structure of an indication layer constituting an indication member of the present invention.

### DETAILED DESCRIPTION OF THE PREFERRED EMBODIMENT

Hereafter, the preferred embodiments of the present invention will be explained concretely. However, the present invention is not limited to these embodiments.

The indication member of the present invention comprises an indication layer capable of exhibiting a structural color. The indication layer causes a structural color change irreversibly by receiving an external stimulus and maintains a structural color obtained from this structural color change.

In the indication member of the present invention, the indication layer can be structured such that in a matrix, a plurality of spherical particle layers each including spherical particles having a refractive index different from that of a matrix are arranged regularly in the thickness direction of the indication layer.

In the indication member, it is desirable that the layer spacing distance of the spherical particle layer in the indication layer changes by receiving a stimulus from the outside.

In the indication member of the present invention, it is desirable that the stimulus from the outside is an application of an external force, a temperature change and a humidity change.

In the indication member of the present invention, it is desirable that the absolute value of the difference between the refractive index of the spherical particles and that of the matrix is 0.02 to 2.0.

In the indication member of the present invention, it is desirable that the average particle size of the spherical particles is 50 nm to 500 nm.

The structural color is not a color caused by the absorption of light by dyes and is a color caused by the selective reflection of light by a periodical structure. As examples of the structural color, colors caused by thin-film interference, light scattering ((Rayleigh scattering, Mie scattering), multilayer interference, diffraction, a diffraction grating, a photonic crystal, and so on may be listed.

A color represented by, for example, the following formula (1) may be indicated as a typical color of the structural color in the indication member of the present invention. Here, the following formulas (1) and (2) are approximate expressions, there may be a case where these calculated values do not conform completely with the structural color.

λ=2nD(cos θ) Formula (1)

Here, in Formula (1), λ represents the peak wavelength of a structural color, n represents the refractive index of an indication layer represented by the following Formula (2), D represents the layer spacing distance of spherical particle layers, and θ represents an observation angle for a vertical line of an indication member.

n=(na·c)+(nb−(1−c)) Formula (2)

Here, in Formula (2), na represents the refractive index of spherical particles, nb represents the refractive index of a matrix, and c represents a volume ratio of spherical particles in an indication layer.

Further, the indication member of the present invention may be made into the shape of a sheet.

According to the indication member of the present invention, the structure of an indication layer capable of exhibiting a structural color by receiving an external stimulus changes irreversibly. Therefore, the structural color after the changing can be maintained semipermanently. Thereby, for example, in the case that the indication member of the present invention is used as a sensor, it can be possible to notice the history without attending at the time of the detection of an external stimulus. Further, for example, in the case that the indication member of the present invention is used as a display, it is not necessary to apply continuously a stimulus to form an image to be indicated on the display. Therefore, an image can be indicated continuously with a small amount of energy.

### (Indication Layer)

The indication layer of the indication member is a layer capable of exhibiting a structural color. More concretely, in a matrix, a plurality of spherical particle layers each including spherical particles having a refractive index different from that of the matrix are arranged regularly in the thickness direction so as to form a periodical structure. By the formation of such a periodical structure in the indication layer, chromatic color becomes visual by the irradiation of light in a visible range.

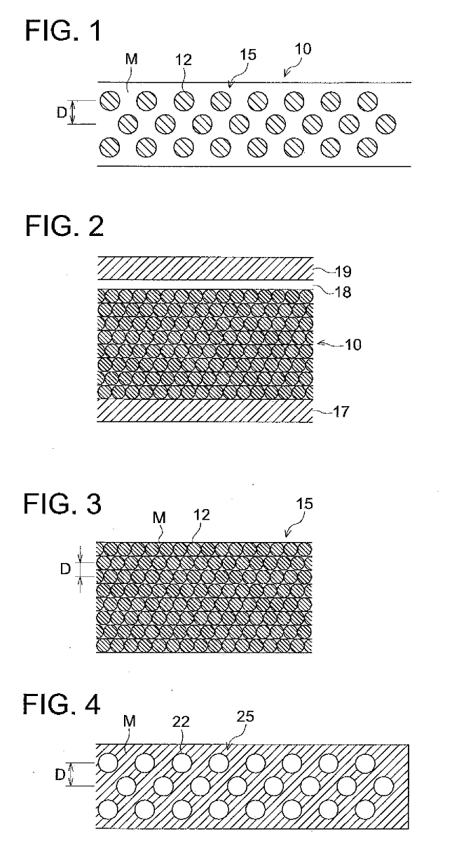

Concretely, as shown in FIG. 1, the indication layer 10 can be structured such that a spherical particle layer 15 is formed on the condition that spherical particles 12 composed of, for example, solid spherical particles come in no contact with each other and a plurality of spherical particle layers 15 are arranged regularly in the thickness direction in a matrix M on the condition that the plurality of spherical particle layers 15 come in no contact with each other. Further, as shown in FIG. 2, the indication layer 10 can be structured such that a plurality of spherical particle layers 15 are arranged regularly on the condition where spherical particles 12 come in contact with each other in the layer direction and also come in contact with each other in the thickness direction.

### (Structural Color)

The structural color is a color of a wavelength represented by the above formula (1) according to Bragg's law and a Snell's law.

In the indication member of the present invention, the matrix M causes transfiguration by receiving an external stimulus, and with this transfiguration, the position of the spherical particles layers 15 in the matrix M displace irreversibly in the thickness direction and the layer spacing distance D changes. As a result, a structural color change is caused. Here, the change of the layer spacing distance D due to the transfiguration of the matrix M includes the change caused by the deformation of spherical particles 12 accompanying with the transfiguration of the matrix M. It may be considered that the influence of this deformation of spherical particles 12 is small.

Subsequently, due to the change of the layer spacing distance D, the peak wavelength λ of the structural color change. That is, the structural color after the receiving of the external stimulus changes.

Here, the indication member of the present invention changes in response to an external stimulus from a structure exhibiting an initial structural color to another well-ordered structure exhibiting a new structural color and does not change at random from the initial structure to a disordered structure incapable of exhibiting a structural color.

Here, the peak wavelength λ of a structural color can be measured by the use of, for example, a spectrocolorimeter “CM-3600d” (manufactured by Konica Minolta Sensing Corporation) under the condition that the observation angle is 8°. Then, a layer spacing distance D can be calculated from this peak wavelength λ of a structural color by the above Formula (1).

In the present invention, the external stimulus is a force to change the layer spacing distance D in the above Formula (1) by transfiguring a matrix M. Specific examples of the external stimulus include temperature change such as heating and cooling, an external force and humidity change. The indication member of the present invention determines a structural color after the changing of the layer spacing distance D based on the strength of the external stimulus. Although there is no specific definition about the strength of the external stimulus, it is preferable that the external stimulus means a force to cause a change of 30 nm or more in the peak wavelength of a structural color of the indication layer 10 represented by the above Formula (1).

In the indication member of the present invention, its structural color and/or the structural color after receiving an external stimulus are not limited to a color having a peak wavelength in a visible range and may be a color having a peak wavelength in ultraviolet region or infrared region. Such an indication member exhibiting a color having a peak wavelength in ultraviolet region or infrared region may be used for, for example, a condition sensor incorporated in a detection device capable of recognizing ultraviolet rays or infrared rays.

In the indication member of the present invention, the absolute value of the difference (hereafter, referred to as “refractive index difference”) between the refractive index of spherical particles 12 and that of a matrix M is desirably 0.02 to 2.0, more desirably 0.1 to 1.6.

In the case that the refractive index difference is 0.02 or more, a structural color becomes easily caused. On the other hand, in the case that the refractive index difference is 2.0 or less, light scattering can be prevented from be caused greatly so that a structural color can be prevented from becoming clouded.

It is necessary to set the average particle size of spherical particles 12 with the relationship between the refractive index of the spherical particles and that of a matrix M. It is preferable that, for example, the size is 50 to 500 nm.

When the average particle size of spherical particles is within the above range, the structural color becomes a color having a peak wavelength in a range of from near-ultraviolet through visible to near-infrared regions. Therefore, a high convenience can be obtained from an indication member capable of obtaining the structural color.

Further, a CV value representing a particle size distribution is preferably 20 or less, more preferably 10 or less, specifically more preferably 5 or less.

In the case that the CV value is more than 20, spherical particle layers including such particles cannot be arranged regularly in a matrix. As a result, there may be a fear that an indication member exhibiting a structural color is not obtained.

The average particle size can be obtained in such a way that particles are photographed with a magnification of 50,000 times by a scanning electron microscope “JSM-7410” (manufactured by JEOL Co., Ltd.), the longest length of each of 200 spherical particles in the photograph is measured and the average length is calculated from the measurements. Here, “the longest length” means the longest one among the distance between two points by arbitrary two points on the periphery of a spherical particle.

Here, in the case that spherical particles are photographed as an aggregate, the longest length of primary particles (spherical particle) constituting the aggregate is to be measured.

The CV value can be calculated by the following Formula (CV) by the use of standard deviation in a number-based particle size distribution and the value of the average particle size.

CV value (%)=((standard deviation)/(average particle size))×100 Formula (CV)

The thickness of a spherical particle layer is, for example, preferably 0.1 to 100 μm.

In the case that the thickness of a spherical particle layer is 0.1 μm or more, the color of the obtained structural color becomes proper density. On the other hand, in the case that the thickness of a spherical particle layer is 100 μm or less, light scattering can be prevented from being caused greatly, whereby the structural color can be prevented from becoming clouded.

The periodic number of the spherical particle layer 15 in the indication layer 10 needs to be at least one or more, and is preferably 5 to 500. In other words, the preferable number of stacked layers of the spherical particle layer 15 is 5 to 500 layers. When the periodic number is one or more, the indication layer can exhibit a structural color.

Further, the layer spacing distance D in the indication layer 10 is desirably 50 to 500 nm irrespective of before and after receiving an external stimulus. When the layer spacing distance D is 50 nm or more, the obtained indication layer can exhibit a structural color.

The thickness of the indication layer 10 may become different in accordance with the usage of it. However, it may be, for example, 0.1 to 100 μm.

### (Spherical Particle)

In the present invention, the spherical particles are a substance having a spherical shape in a three dimension and are preferably shaped in a true sphere. However, the shape is not necessarily limit to a true sphere, and may be approximately a spherical shape. That is, the spherical particles may have a similar shape to each other and, for example, may have a shape to cause a change of 30 nm or more in a peak wavelength of a structural color in the above formula (1) be receiving an external stimulus. The substance may have any configuration of solid, liquid and gas and may be enough to satisfy the condition that it has a refractive index different from that of a matrix.

Here, the true sphere of spherical particles means that the average value of SF1 values is 100 to 110, wherein the SF-1 values is obtained such that SEM pictures of 100 spherical particles are photographed randomly with a magnification of 10,000 times by a scanning type electron microscope (SEM), the SEM pictures are analyzed by the use of an image processing analyzing device (LUZEX AP manufactured by Nireco Corporation) and the SF-1 values is calculated by the following Formula (3).

SF-1 value=(the maximum length of particle)²/(the projection area of the particle)×(π/4)×100 Formula (3)

Here, in Formula (3), the maximum length of particle is the width of the particle when the projection image of a particle on a plane is sandwiched between two parallel lines and the gap distance between the two parallel lines becomes the maximum, and the projection area of the particle is the area of the projection image of a particle on a plane.

In the case that a spherical particle layer in an indication layer is formed to contain a spherical particle made of a solid substance, various compositions may be listed as the solid substance.

Specific examples of spherical particles made of organic substances include spherical particles produced by polymerization of one kind of the following polymerizable monomers or spherical particles produced by copolymerization of two kind or more of the following polymerizable monomers: such as styrene monomers, such as styrene, methylstyrene, methoxy styrene, butyl styrene, phenylstyrene, and a chlorostyrene; acrylic acid ester monomers, or methacrylic acid ester system monomers, such as methyl acrylate, ethyl acrylate, propyl acrylate (iso), butyl acrylate, hexyl acrylate, octyl acrylate, acrylic acid ethyl hexyl, methyl methacrylate, ethyl methacrylate, butyl methacrylate, and methacrylic acid ethyl hexyl; and carboxylic monomers, such as acrylic acid, methacrylic acid, itaconic acid, and fumaric acid. Further, spherical particles may be spherical particles produced by polymerization of polymerizable monomers added with cross-linking monomers, and examples of cross-linking monomers include divinylbenzene, ethylene glycol dimethacrylate, tetraethylene glycol dimethacrylate, trimethylol pro pantry methacrylate, and the like.

Further, examples of inorganic substances to form spherical particles include inorganic oxides and multiple oxides, such as silica, titanium oxide, aluminium oxide, and copper oxide; glass; ceramics; and the like.

The refractive index of spherical particles 12 may be measured by various well-known methods. However, the refractive index of spherical particles of the present invention is a value measured by the immersion method.

Specific examples of the refractive index of spherical particle 12 are, for examples, 1.59 of polystyrene, 1.49 of polymethyl methacrylate, 1.60 of polyester, 1.40 of fluorine modified polymethyl methacrylate, 1.56 of copolymer of polystyrene and butadiene, 1.48 of polymethyl acrylate, 1.47 of polybutyl acrylate, 1.45 of silica, 2.52 of titanium oxide (anatase type), 2.76 of titanium oxide (rutile type) 2.71 of copper oxide, 1.76 of aluminium oxide, 1.64 of barium sulfate and 3.08 of ferric oxide.

A spherical particle constituting a spherical particle layer may be a single particle made of a single composition or a compound. The surface of the spherical particle may be adhered with a material to adhere spherical particles to each other, or a material to adhere spherical particles to each other is introduced into the inside of the particle.

By the use of such an adhesive material, at the time of forming a spherical particle layer, spherical particles can be adhered to each other even if the spherical particles are made of material to cause hardly self-arrangement. Further, in the case that spherical particles are made of a material having a high refractive index, a material having a low refractive index may be added in the spherical particles.

Spherical particles constituting a spherical particle layer have preferably high monodispersity, because it may be easy to arrange them regularly at the time of forming a spherical particle layer. In order to obtain such particles having high monodispersity, in the case that spherical particles are made of organic substances, it is preferable to produce spherical particles by commonly used polymerizing methods, such as a soap free emulsion polymerization method, a suspension polymerization method, and an emulsion polymerization.

Spherical particles may be subjected to various surface treatment in order to provide them with affinity them to a matrix M.

The matrix M in an indication layer 10 may be appropriately selected by the combination with the material of spherical particles constituting a spherical particle layer in accordance with the usage of it.

As a matrix to cause transfiguration due to temperature change, listed is a matrix having a glass transition point or a melting point and to cause transfiguration by these factor, and specific examples of the matrix include various polymers such as polyvinyl alcohol and natural products.

As a matrix to cause transfiguration due to an external force, listed is a matrix to cause deformation between from a yield point to a fracture point, and specific examples of the matrix include polyethylene (low density), polystyrene, gelatin, and the like.

It is possible to design to use a matrix having a high yield point in combination with a matrix having a low yield point so as to cause a plastic deformation with a small external force.

Further, by the use of a matrix whose elastic range is specified to a yield point, an indication layer can be structured so as to specify the size of an external force to cause a structural color change.

If the elastic range of a matrix is specified with a large external force, in the case that the matrix receives a smaller external force than the large external force, even if the matrix causes a structural color change, when the smaller external force is removed, the structural color of the matrix returns to the original structural color. Therefore, it is possible to obtain an indication member in which only when a matrix receive a large external force, the changed structural color can be fixed. Therefore, this indication member can be used conveniently as a sensor to detect the maximum stress.

Further, as a matrix to cause transfiguration due to a humidity change, listed is a matrix not to discharge moisture if having absorbed once moisture, or to need long time to discharge moisture, and specific examples of the matrix include water absorptive polymer, such as polyacrylate type polymer, lignin type polymer, chitosan type polymer, and polyaspartic acid type polymer.

The material of the matrix M needs to have a refractive index different from that of spherical particles and to be not compatible with a material constituting spherical particles. Further, the matrix M is preferably made of a material having high affinity with spherical particles 12.

The refractive index of the matrix M can be measured by various well-known methods. However, the refractive index of the matrix M of the present invention is measured in such a way that a thin film made of only the matrix M is formed separately and the refractive index is a value of the thin film measured by Abbe refractometer.

Examples of the refractive index of the matrix M are for example, 1.53 of gelatin/gum Arabic, 1.51 of polyvinyl alcohol, 1.51 of sodium polyacrylate, 1.34 of fluorine modified acrylate resin, 1.51 of N-isopropylamide and 1.43 of foamed acrylate resin.

The above mentioned indication layer 10 maintain a changed structural color by having received once an external stimulus. However, the indication layer can cause again a structural color change by receiving again an external stimulus and change further it to another structural color.

### (Indication Member)

The above mentioned indication member can be configured concretely such that for example as shown in FIG. 2, a substrate 17, an indication layer 10 formed on the surface of the substrate 17, a surface cover layer 19 provided via an adhesive layer 18 on the indication layer are laminated in this order in a shape of a sheet.

In such an indication member, the substrate 17, the adhesive layer 18 and the surface cover layer 19 are provided if needed in accordance with the usage of the indication member Further, it may be configured such that an adhesive layer for label may be provided on the reverse surface of the substrate 17 or the reverse surface of the indication layer 10.

As the substrate 17, for example, a filter or sheet of glass, ceramics, polyethylene terephthalate (PET), and polyethylenenaphthalate (PEN) can be employed.

In the case that the indication layer 10 is produced by the use of water dispersion liquid of spherical particles 12, it is desirable to use a substrate having a contact angle being low to some extent to water on its surface as the substrate 17. Further, the substrate can be subjected to a proper surface treatment, because it is preferable for the substrate to have a high surface smoothness. Moreover, the substrate can also be used on the condition that the substrate is subjected to a blasting treatment so as to make it easy for spherical particles to adhere on its surface.

In the case of providing a surface cover layer 19, as the surface cover layer 19, employed is a film having a high transparency and not preventing the indication layer from exhibiting a structural color, such as a film made of polyethylene terephthalate (PET) and polyethylenenaphthalate (PEN), and a film made of UV curable resin.

Further, in the case of constituting such that an indication member causes color change by an external stimulus of a humidity change, a moisture permeable film may be used as the surface cover layer 19.

Further, in the case of using a label, adhesive materials of a temporary adhesive property, such as an acrylic adhesive and an acrylic olefin copolymerization adhesive can be used as an adhesive layer for labels, for example.

As methods of forming an indication layer in the indication material of the present invention, in the case that spherical particles are solid phase particles, preferably employed is a method of preparing water dispersion liquid of the particles, coating the liquid on the surface of a substrate, thereafter filling a material to form a matrix in gaps between particles so as to form a first layer, forming a layer composed of only the material to form he matrix on the first layer, and repeating the above steps.

As a coating method, employed is a screen coating method, a dip coating method, a spin coating method, a curtain coating method, and a LB (Langmuir-Blodgett) layer producing method and the like.

According to the above indication member, by receiving an external stimulus, since the structure of the indication layer 10 to exhibit a structural color changes irreversibly, the structural color after the changing can be maintained semipermanently.

With this, for example, in the case that the indication member is used as a sensor, it is possible for a user to know the history even if the user does not attend at the time of detecting an external stimulus. Further, for example, in the case that the indication member is used as a display, since it is not necessary to continue applying a stimulus to form an image to be indicated on the display, the image can be indicated with a small amount of energy.

As described above, the embodiments of the present invention have been explained in detail. However, the embodiments of the present invention are not limited to the above embodiments so that various modification can be applied.

For example, as far as a periodical structure is formed in the thickness direction, the concrete structure of the indication layer is not limited specifically. As indicated in FIG. 3, the indication layer may be structured such that spherical particle layers 15 each formed by spherical particles 12 coming in contact with each other are arranged regularly in the thickness direction so as to come in contact with each other in a matrix M.

Further, for example, spherical particles are not limited solid phase particles. As far as particles have a refractive index different from that of a material constituting a matrix, the particles may be gaseous phase bubble pores 22. In FIG. 4, the indication layer may be structured such that spherical particle layers 25 each formed by bubble pores serially connected to each other are arranged regularly in the thickness direction so as to connect serially with each other in a matrix M.

In the case where spherical particles are bubble pores, an indication layer can be obtained in such a way that a layer to become a spherical particle layer is formed in a matrix by resin particles formed by, for example, styrene acrylic resin, and thereafter, the resin particles are removed by being immersed and dissolved in, for example, tetrahydrofuran (THF).

The average pore size of bubble pores needs to be set in relation with the refractive index of a matrix. However, it may be desirable that it is 50 to 500 nm. Further, a CV value representing a distribution of pore size is preferably 20 or less, more preferably 10 or less, specifically more preferably 5 or less.

With regard to the average pore size, the cut piece of a cross section of an indication layer 10 is photographed with a magnification of 50,000 times, the size of each of 100 pores is measured visually, and the number average size of the measurement values is made as an average pore size. The CV value relating to the average pore size is calculated by the above Formula (CV) by the use of the value of this average pore size.

Further, all spherical particles are not limited to solid spherical particles or gaseous bubble pores and are constituted so as to include both of them.

In the case that spherical particles in an indication layer include both of solid spherical particles or gaseous bubble pores, the refractive index na of spherical particles in order to calculate the refractive index of an indication layer can be obtained by the use of the following Formula (3).

na=(na1·d)+(na2·(1−d)) Formula (3)

In the Formula (3), na1 represents the refractive index of solid spherical particles, na2 represents the refractive index of gaseous bubble pores and d represents a volume ratio of solid spherical particles.

Further, for example, in a spherical particle layer, spherical particles are arranged regularly in a one direction with regard to the incident direction of light. Especially, as an arrangement of spherical particles, preferable is an arrangement in which a spherical layer exhibits the most closely packed structure.

### EXAMPLE

Hereafter, concrete examples of the present invention will be explained. However, the present invention is not limited to these examples.

### Preparation Example 1 of Fine Particle Dispersion Liquid

### (Synthesis of Sphere)

A monomer mixed solution was prepared by a process of warming 71 parts by weight of styrene (St), 20 parts by weight of n-butyl acrylate (BA), and 9 parts by weight of methacrylic acid (MAA) to 80° C. On the other hand, a surfactant solution in which 0.4 parts by weight of dodecyl sulfonic acid sodium was dissolved in 263 parts by weight of ion-exchange water was heated to 80° C., and this surfactant solution and the above monomer mixed solution were mixed and then subjected to a dispersing process for 30 minutes by a mechanical dispersion device “CLEARMIX” (manufactured by M-Technique Co., Ltd.), whereby an emulsion dispersion liquid was prepared.

Into a reaction container equipped with a stirring device, a heating cooling device, a nitrogen introducing device, and a raw material and auxiliary agent feeding devices the above emulsion dispersion liquid and a surfactant solution in which 0.1 parts by weight of dodecyl sulfonic acid sodium was dissolved in 142 parts by weight of ion-exchange water were supplied and stirred with a stirring speed of 200 rpm under a current of nitrogen while an inside temperature was heated to 80° C. Into the resultant solution, 1.4 parts by weight of potassium persulfate and 54 parts by weight of water were added and then a polymerizing process was conducted for three hours, whereby a fine particle dispersion liquid was obtained. Further, large size particles and small size particles were separated from the fine particle dispersion liquid by a centrifugal separator, whereby a fine particle dispersion liquid (hereafter, referred to as Fine particle dispersion liquid (1)) having high mono-dispersibility was obtained. The average particle size, CV value and refractive index of fine particles in this Fine particle dispersion liquid (1) are indicated in Table 1.

### Preparation Example 2 of Fine Particle Dispersion Liquid

Into a surfactant solution in which 0.02 parts by weight of dodecyl sulfonic acid sodium was dissolved in 100 parts by weight of ion-exchange water, 20 parts by weight of spherical particles of titanium oxide (rutile-type, average particle size: 120 nm, CV value: 7.1, refractive index 2.76) synthesized by a titanium alkoxide polymerization method were dispersed, whereby Fine particle dispersion liquid (2) was obtained. The average particle size, CV value and refractive index of fine particles in this Fine particle dispersion liquid (2) are indicated in Table 1.

### Preparation Example 3 of Fine Particle Dispersion Liquid

Ten parts by weight of polyester (PEs) was dissolved in 40 parts by weight of toluene, whereby a polyester dispersion liquid was prepared. This polyester dispersion liquid was mixed with a surfactant solution in which 0.2 parts by weight of dodecyl sulfonic acid sodium was dissolved in 200 parts by weight of ion-exchange water, and the resultant mixture was subjected to a dispersion process for 30 minutes by a mechanical dispersion device “CLEARMIX” (manufactured by M-Technique Co., Ltd.), whereby an emulsion dispersion liquid was prepared. This emulsion dispersion liquid was heated at 60° C. under a reduced pressure so as to evaporate toluene, whereby Fine particle dispersion liquid (3) composed of true spherical fine particles with high monodispersity was obtained. The average particle sizes CV value and refractive index of fine particles in this Fine particle dispersion liquid (3) are indicated in Table 1.

### Preparation Example 4 of Fine Particle Dispersion Liquid

Into a surfactant solution in which 0.02 parts by weight of dodecyl sulfonic acid sodium was dissolved in 100 parts by weight of ion-exchange water, 20 parts by weight of spherical particles of titanium oxide (anatasetype, average particle size: 105 nm, CV value: 6.5, refractive index 2.52) synthesized by a titanium alkoxide polymerization method were dispersed, whereby Fine particle dispersion liquid (4) was obtained. The average particle size, CV value and refractive index of fine particles in this Fine particle dispersion liquid (4) are indicated in Table 1.

### Preparation Example 5 of Fine Particle Dispersion Liquid

A monomer solution was prepared by a process of warming 100 parts by weight of methyl methacrylate (MMA) to 80° C. On the other hand, a surfactant solution in which 0.4 parts by weight of dodecyl sulfonic acid sodium was dissolved in 263 parts by weight of ion-exchange water was heated to 80° C., and this surfactant solution and the above monomer solution were mixed and then subjected to a dispersing process for 30 minutes by a mechanical dispersion device “CLEARMIX” (manufactured by M-Technique Co., Ltd.), whereby an emulsion dispersion liquid was prepared.

Into a reaction container equipped with a stirring device, a heating cooling device, a nitrogen introducing device, and a raw material and auxiliary agent feeding device, the above emulsion dispersion liquid and a surfactant solution in which 0.1 parts by weight of dodecyl sulfonic acid sodium was dissolved in 142 parts by weight of ion-exchange water were supplied and stirred with a stirring speed of 200 rpm under a current of nitrogen while an inside temperature was heated to 80° C. Into the resultant solution, 1.4 parts by weight of potassium persulfate and 54 parts by weight of water were added and then a polymerizing process was conducted for three hours, whereby a fine particle dispersion liquid composed of true spherical fine particles with high monodispersity was obtained. Further, large size particles and small size particles were separated from the fine particle dispersion liquid by a centrifugal separator, whereby Fine particle dispersion liquid (5) having a narrow particle size distribution was obtained. The average particle size, CV value and refractive index of fine particles in this Fine particle dispersion liquid (5) are indicated in Table 1.

### Preparation Example 6 of Fine Particle Dispersion Liquid

Into a surfactant solution in which 0.3 parts by weight of dodecyl sulfonic acid sodium was dissolved in 500 parts by weight of ion-exchange water, 100 parts by weight of melamine formaldehyde condensation particles “EPOSTAR S” (produced by NIPPON SHOKUBAI Co., Ltd.) were dispersed, and large size particles and small size particles were separated from the resultant dispersion liquid by a centrifugal separator, whereby Fine particle dispersion liquid (6) having a narrow particle size distribution was obtained. The average particle size, CV value and refractive index of fine particles in this Fine particle dispersion liquid (6) are indicated in Table 1.

### Preparation Example 7 of Fine Particle Dispersion Liquid

Into 90 parts by weight of toluene, 10 parts by weight of polyester and 90 parts by weight of ferric trioxide were subjected to a dispersing process for 30 minutes by a mechanical dispersion device “CLEARMIX” (manufactured by M-Technique Co., Ltd.), whereby a polyester/ferric trioxide dispersion liquid was prepared. This liquid was mixed with a surfactant solution in which 0.4 parts by weight of dodecyl sulfonic acid sodium was dissolved in 400 parts by weight of ion-exchange water, and the resultant mixed liquid was subjected to a dispersing process for 30 minutes by a mechanical dispersion device “CLEARMIX” (manufactured by M-Technique Co., Ltd.), whereby an emulsion dispersion liquid was prepared.

This emulsion dispersion liquid was heated at 60° C. under a reduced pressure so as to evaporate toluene, whereby a dispersion liquid composed of true spherical fine particles in which ferric trioxide was dispersed in a polyester resin was obtained, and large size particles and small size particles were separated from the dispersion liquid by a centrifugal separator, whereby Fine particle dispersion liquid (7) having a narrow particle size distribution was obtained. The average particle size, CV value and refractive index of fine particles in this Fine particle dispersion liquid (7) are indicated in Table 1.

### Preparation Example 8 of Fine Particle Dispersion Liquid

A mixed solution composed of 47.4 parts by weight of methanol, 12.6 parts by weight of pure water and 3.0 parts by weight of ammonia was prepared, and this mixed solution was put into a reaction container equipped with a stirring device, a heating cooling device, a nitrogen introducing device, and a raw material and auxiliary agent feeding device, and 22.8 parts by weight of silicone methoxide was dropped in the mixed solution so as to conduct hydrolysis while stirring the solution at a temperature of 20° C., whereby Fine particle dispersion liquid (8) having a narrow particle size distribution was obtained. Fine particles in this Fine particle dispersion liquid (8) have a average particle size of 300 nm, a CV value of 5.1 and a refractive index of 1.45.

### Preparation Example 9 of Fine Particle Dispersion Liquid

Into a surfactant solution in which 0.28 parts by weight of dodecyl sulfonic acid sodium was dissolved in 500 parts by weight of ion-exchange water, 100 parts by weight of melamine formaldehyde condensation particles “EPOSTAR S” (produced by NIPPON SHOKUBAI Co., Ltd.) were dispersed, and large size particles and small size particles were separated from the resultant dispersion liquid by a centrifugal separator, whereby Fine particle dispersion liquid (9) having a narrow particle size distribution was obtained. The average particle size, CV value and refractive index of fine particles in this Fine particle dispersion liquid (9) are indicated in Table 1.

### Preparation Example 10 of Fine Particle Dispersion Liquid

Into a surfactant solution in which 0.02 parts by weight of dodecyl sulfonic acid sodium was dissolved in 100 parts by weight of ion-exchange water, 20 parts by weight of spherical particles of titanium oxide (anatase-type, average particle size: 260 nm, CV value: 6.5, refractive index 2.52) synthesized by a titanium alkoxide polymerization method were dispersed, whereby Fine particle dispersion liquid (10) was obtained. The average particle size, CV value and refractive index of fine particles in this Fine particle dispersion liquid (10) are indicated in Table 1.

### Preparation Example 11 of Fine Particle Dispersion Liquid

Into 40 parts by weight of toluene, 10 parts by weight of polyester and 2 parts by weight of titanium oxide were subjected to a dispersing process for 30 minutes by a mechanical dispersion device “CLEARMIX” (manufactured by M-Technique Co., Ltd.), whereby a polyester/titanium oxide dispersion liquid was prepared. This liquid was mixed with a surfactant solution in which 0.2 parts by weight of dodecyl sulfonic acid sodium was dissolved in 200 parts by weight of ion-exchange water, and the resultant mixed liquid was subjected to a dispersing process for 30 minutes by a mechanical dispersion device “CLEARMIX” (manufactured by M-Technique Co., Ltd.), whereby an emulsion dispersion liquid was prepared.

This emulsion dispersion liquid was heated at 60° C. under a reduced pressure so as to evaporate toluene, whereby a dispersion liquid composed of true spherical fine particles in which titanium oxide was dispersed in a polyester resin was obtained, and large size particles and small size particles were separated from the dispersion liquid by a centrifugal separator, whereby Fine particle dispersion liquid (11) having a narrow particle size distribution was obtained. The average particle size, CV value and refractive index of fine particles in this Fine particle dispersion liquid (11) are indicated in Table 1.

### Example 1

### Structural Color Change by an External Force

### Production Example 1 of an Indication Member

Fine particle dispersion liquid (1) was coated by a bar coat method on a black polyethylene terephthalate (PET) sheet having been subjected to a hydrophilic treatment and dried so that a spherical particle containing layer having a thickness of 20 μm was formed. Subsequently, an aqueous 10 wt % gelatin/gum arabic (ArG) (9/1) solution was coated on the spherical particle containing layer so as to make the coating solution penetrate between spherical particles, and dried so that a gelatin/gum arabic layer having a thickness of 2 μm was formed on the spherical particle containing layer. Further, a transparent PET film with a thickness of 5 μm was covered and adhered with a transparent acrylic adhesive on it, whereby a sheet-shaped indication member (1) was obtained. This indication member (1) exhibited green. The refractive index of the matrix is shown in Table 1.

### (Evaluation of the Structural Color Change by an External Force)

A tool for pulling was adhered on this green sheet, and this tool was pulled upward with a force of 10 kgf. As a result, the color of the sheet changed to red. After one day has passed, it was acknowledged that the red has been still maintained. The results are shown in Table 1.

From the above, it was confirmed that this indication member (1) detected the pulling force and maintained the history of the structural color change.

### Example 2

### Structural Color Change by an External Force

### Production Example 2 of an Indication Member

Fine particle dispersion liquid (2) was coated by a bar coat method on a black PET sheet having been subjected to a hydrophilic treatment and dried so that a spherical particle containing layer having a thickness of 2 μm was formed. Subsequently, a matrix solution composed of 50 parts by weight of perfluorophenyl acrylate, 4 parts by weight of dinitrosopentamethylene tetramine (foaming agent) and 0.1 parts by weight of 2,4,6-trimethyl benzoyl diphenyl phosphin oxide (photopolymerization initiator) was coated on the spherical particle containing layer so as to make the coating solution penetrate between spherical particles, and thereafter, a photo-curing treatment was conducted by the use of a high-pressure mercury lamp on it so that a stroma layer having a thickness of 2 μm was formed on the spherical particle containing layer Further, a transparent PET film with a thickness of 5 μm was covered and adhered with a transparent acrylic adhesive on it, whereby a sheet-shaped indication member (2) was obtained. This indication member (2) exhibited green. The refractive index of the matrix is shown in Table 1.

### (Evaluation of the Structural Color Change by an External Force)

A tool for pulling was adhered on this green sheet, and this tool was pulled upward with a force of 10 kgf. As a result, the color of the sheet changed to red. After one day has passed, it was acknowledged that the red has been still maintained. The results are shown in Table 1.

From the above, it was confirmed that this indication member (2) detected the pulling force and maintained the history of the structural color change.

### Example 3

### Structural Color Change by an External Force

### Production Example 3 of an Indication Member

Fine particle dispersion liquid (3) was coated by a bar coat method on a glass plate having been subjected to a hydrophilic treatment and dried so that a spherical particle containing layer having a thickness of 2 μm was formed. Subsequently, an aqueous 10 wt % polyvinyl alcohol (PVA)/gum arabic (ArG) (8/2) solution was coated on the spherical particle containing layer so as to make the coating solution penetrate between spherical particles, and dried so that a polyvinyl alcohol/gum arabic layer having a thickness of 2 μm was formed on the spherical particle containing layer. Further, a transparent PET film with a thickness of 5 μm was covered and adhered with a transparent acrylic adhesive on it, thereafter, this laminated layers was peeled off from the glass plate. Then, the reverse surface of the laminated layers (the side having contacted with the glass plate) was coated with a black acrylic adhesive, whereby a label-shaped indication member (3) was obtained. This indication member (3) exhibited green. The refractive index of the matrix is shown in Table 1.

### (Evaluation of the Structural Color Change by an External Force)

This green label was pasted on a paper box and then was peeled from the paper box. As a result, the color of the label changed to red. After one day has passed, it was acknowledged that the red has been still maintained The results are shown in Table 1.

From the above, it was confirmed that this indication member (3) had an unauthorized opening preventing function.

### Example 4

### Structural Color Change by an External Force

### Production Example 4 of an Indication Member

A sheet-shaped indication member (4) was obtained in the same way as that in Production example 1 of Example 1 except that Fine particle dispersion liquid (4) was used in place of Fine particle dispersion liquid (1), polyvinyl alcohol (PVA)/gum arabic (Arc) (9/1) was used in place of gelatin/gum arabic (ArG) (9/1) and the thickness of a spherical particle containing layer was made 2 μm in place of 20 μm. This indication member (4) exhibited blue. The refractive index of the matrix is shown in Table 1.

### (Evaluation of the Structural Color Change by an External Force)

A tool for pulling was adhered on this blue sheet, and this tool was pulled upward with a force of 10 kgf. As a result, the color of the sheet changed to yellow. After one day has passed, it was acknowledged that the yellow has been still maintained. The results are shown in Table 1.

From the above, it was confirmed that this indication member (4) detected the pulling force and maintained the history of the structural color change.

### Example 5

### Structural Color Change by an External Force

### Production Example 5 of an Indication Member

A sheet-shaped indication member (5) was obtained in the same way as that in Production example 1 of Example 1 except that Fine particle dispersion liquid (5) was used in place of Fine particle dispersion liquid (1), gelatin/gum arabic (ArG)/titanium oxide (TiO₂) (9/1/2) was used in place of gelatin/gum arabic (ArG) (9/1) and the thickness of a spherical particle containing layer was made 4 μm in place of 20 μm. This indication member (5) exhibited blue. The refractive index of the matrix is shown in Table 1.

### (Evaluation of the Structural Color Change by an External Force)

A tool for pulling was adhered on this blue sheet, and this tool was pulled upward with a force of 10 kgf. As a result, the color of the sheet changed to red. After one day has passed, it was acknowledged that the red has been still maintained. The results are shown in Table 1.

From the above, it was confirmed that this indication member (5) detected the pulling force and maintained the history of the structural color change.

### Example 6

### Structural Color Change by an External Force

### Production Example 6 of an Indication Member

A sheet-shaped indication member (6) was obtained in the same way as that in Production example 2 of Example 2 except that Fine particle dispersion liquid (6) was used in place of Fine particle dispersion liquid (2), and the thickness of a spherical particle containing layer was made 4 μm in place of 2 μm. This indication member (6) exhibited green. The refractive index of the matrix is shown in Table 1.

### (Evaluation of the Structural Color Change by an External Force)

A tool for pulling was adhered on this green sheet, and this tool was pulled upward with a force of 10 kgf. As a result, the color of the sheet changed to red. After one day has passed, it was acknowledged that the red has been still maintained. The results are shown in Table 1.

From the above, it was confirmed that this indication member (6) detected the pulling force and maintained the history of the structural color change.

### Example 7

### Structural Color Change by an External Force

### Production Example 7 of an Indication Member

A sheet-shaped indication member (7) was obtained in the same way as that in Production example 2 of Example 2 except that Fine particle dispersion liquid (7) was used in place of Fine particle dispersion liquid (2). This indication member (7) exhibited green. The refractive index of the matrix is shown in Table 1.

### (Evaluation of the Structural Color Change by an External Force)

A tool for pulling was adhered on this green sheet, and this tool was pulled upward with a force of 10 kgf. As a result, the color of the sheet changed to red. After one day has passed, it was acknowledged that the red has been still maintained. The results are shown in Table 1.

From the above, it was confirmed that this indication member (7) detected the pulling force and maintained the history of the structural color change.

### Example 8

### Structural Color Change by an External Force

### Production Example 8 of an Indication Member

Fine particle dispersion liquid (8) was coated by a bar coat method on a black PET sheet having been subjected to a hydrophilic treatment and dried so that a spherical particle containing layer having a thickness of 4 μm was formed. Subsequently, an aqueous 10 wt % gelatin/gum arabic (ArG)/titanium oxide (TiO₂) (8/2) solution was coated on the spherical particle containing layer so as to make the coating solution penetrate between spherical particles, and thereafter, a photo-curing treatment was conducted by the use of a high-pressure mercury lamp on it so that a stroma layer having a thickness of 2 μm was formed on the spherical particle containing layer. Subsequently, the laminated sheet was immersed in 20% fluoric acid so as to dissolve silica, and thereafter was washed with water and dried, whereby a sheet-shaped indication member (8) was obtained. This indication member (8) exhibited red. The refractive index of the matrix and the average particle size, CV value and refractive index of spherical particles (air bubbles) are shown in Table 1.

### (Evaluation of the Structural Color Change by an External Force)

A force of 10 kgf was applied so as to press on this red sheet. As a result, the color of the sheet changed to green. After one day has passed, it was acknowledged that the green has been still maintained. The result is shown in Table 1.

From the above, it was confirmed that this indication member (8) detected the pressing force and maintained the history of the structural color change.

### Example 9

### Structural Color Change by a Temperature Change and an External Force

### Production Example 9 of an Indication Member

Fine particle dispersion liquid (9) was coated by a bar coat method on a black PET sheet having been subjected to a hydrophilic treatment and dried so that a spherical particle containing layer having a thickness of 4 μm was formed. Subsequently, a matrix solution composed of 58 parts by weight of vinyl chloride resin, 15 parts by weight of phthalic acid di-2-ethyl hexyl (plasticizer), 4 parts by weight of dinitrosopentamethylene tetramine (foaming agent) and 100 parts by weight of toluene was coated on the spherical particle containing layer so as to make the coating solution penetrate between spherical particles, and dried so that a stroma layer having a thickness of 2 μm was formed on the spherical particle containing layer, whereby a sheet-shaped indication member (9-1) was obtained. This indication member (9-1) exhibited blue The refractive index of the matrix is shown in Table 1.

### (Evaluation of the Structural Color Change by the Temperature Change)

This blue sheet was placed for two hours under the environment of 100° C. As a result, the color of the sheet changed to yellow. Even after the temperature was returned to a room temperature, it was acknowledged that the yellow has been still maintained The results are shown in Table 1.

From the above, it was confirmed that this indication member (9-1) detected the temperature change and maintained the history of the structural color change.

This sheet whose color was changed to yellow was made as an indication member (9-2).

### (Evaluation of the Structural Color Change by an External Force)

A force of 10 kgf was applied so as to press on this yellow sheet. As a result, the color of the sheet changed to green. After one day has passed, it was acknowledged that the green has been still maintained. The results are shown in Table 1.

From the above, it was confirmed that this indication member (9-2) detected the pressing force and maintained the history of the structural color change.

### Example 10

### Structural Color Change by a Temperature Change

### Production Example 10 of an Indication Member

Fine particle dispersion liquid (10) was coated by a bar coat method on a black PET sheet having been subjected to a hydrophilic treatment and dried so that a spherical particle containing layer having a thickness of 4 μm was formed. Subsequently, a matrix solution composed of 5.8 parts by weight of vinyl chloride resin, 1.5 parts by weight of phthalic acid di-2-ethyl hexyl (plasticizer), 0.4 parts by weight of sodium silicate (foaming agent) and 100 parts by weight of toluene was coated on the spherical particle containing layer so as to make the coating solution penetrate between spherical particles, and dried so that a stroma layer having a thickness of 2 μm was formed on the spherical particle containing layer, whereby a sheet-shaped indication member (10-1) was obtained. This indication member (10-1) exhibited green. The refractive index of the matrix is shown in Table 1.

### (Evaluation of the Structural Color Change by a Temperature Change)

This green sheet was placed for two hours under the environment of 100° C. As a result, the color of the sheet changed to red. Even after the temperature was returned to a room temperature, it was acknowledged that the red has been still maintained. The results are shown in Table 1.

From the above, it was confirmed that this indication member (10-1) detected the temperature change and maintained the history of the structural color change.

### Example 11

### Structural Color Change by a Humidity Change

### Production Example 11 of an Indication Member

Fine particle dispersion liquid (11) was coated by a bar coat method on a black PET sheet having been subjected to a hydrophilic treatment and dried so that a spherical particle containing layer having a thickness of 10 μm was formed. Subsequently, a 10 wt % polyacrylic acid sodium solution was coated on the spherical particle containing layer so as to make the coating solution penetrate between spherical particles, and dried so that a stroma layer having a thickness of 2 μm was formed on the spherical particle containing layer, whereby a sheet-shaped indication member (11) was obtained. This indication member (11) exhibited blue. The refractive index of the matrix is shown in Table 1.

### (Evaluation of the Structural Color Change by a Humidity Change)

This blue sheet was shifted from the normal environment (humidity 40%) to the environmental (Humidity 100%) and placed for two hours. As a result, the color of the sheet changed to red. Even after the environmental was returned to the normal environment (humidity 40%), it was acknowledged that the red has been still maintained The result is shown in Table 1.

From the above, it was confirmed that this indication member (11) detected the humidity change and maintained the history of the structural color change.

### Comparative Example 1

### Structural Color Change by an External Force

### Production Example 12 of an Indication Member

A dispersion liquid of a monodisperse polystyrene fine particles “Polybead Polystyrene Microsphere 0.20 μm” (produced by Polysciences Co., Ltd.) with an average particle size of 202 μm was coated by a bar coat method on a black PET sheet having been subjected to a hydrophilic treatment and dried so that a spherical particle containing layer having a thickness of 10 μm was formed. Subsequently, a polydimethyl silicone gell precursor polymer solution was coated on the spherical particle containing layer so as to make the coating solution penetrate between spherical particles, dried, and then subjected to a heating treatment at 50° C. for three hours so as to conduct a polydimethyl silicone penetration process to make it solid. The polydimethyl silicone penetration process was conducted repeatedly four times, whereby a sheet-shaped indication member (12) was obtained. This indication member exhibited red. The refractive index of the matrix and the average particle size, CV value and refractive index of spherical particles are shown in Table 1.

### (Evaluation of the Structural Color Change by an External Force)

A tool for pulling was adhered on this red sheet, and this tool was pulled upward with a force of 10 kgf. As a result, the color of the sheet changed to green. However, after the pulling force was removed, it was acknowledged that the color has returned to red. The results are shown in Table 1.

From the above, it was confirmed that this indication member (12) detected the pulling force during the applying of it and the history of the structural color change was not preserved.

### Comparative Example 2

### Structural Color Change Due to an External Force

### Production Example 13 of an Indication Member

A dispersion liquid of silica fine particles “KE-P30” with an average particle size of 291 nm (produced by NIPPON SHOKUBAI Co., Ltd.) was dropped on a glass plate having been subjected to a hydrophilic treatment and dried at 100° C. for three hours so that a spherical particle containing layer having a thickness of 0.5 mm was formed. Subsequently, a solution in which 10 g of N-isopropyl acrylamid, 0.3 g of azobisisobutyronitrile (AIBN), 0.4 g of N,N-methylene bisacrylamid were dissolved in 5 mL of nitrogen-substituted dioxane was coated on the spherical particle containing layer so as to make the coating solution penetrate between spherical particles, then a polymerization process was conducted at 60° C. for 12 hours. Further, subsequently, the resultant plate was immersed in 20% fluoric acid so as to dissolve silica, washed with water, dried and immersed in water, whereby a sheet-shaped indication member (13) was obtained. This indication member exhibited red under the environment of a water temperature of 20° C. The refractive index of the matrix and the average particle size, CV value and refractive index of spherical particles (water bubbles) are shown in Table 1.

### (Evaluation of the Structural Color Change by a Temperature Change)

This red sheet was immersed in a water tank and the water temperature in the water tank was raised to 60° C. As a result, the color of the sheet changed to blue. However, after the water temperature in the water tank was lowered to 20° C., it was acknowledged that the color has returned to red. The result is shown in Table 1.

From the above, it was confirmed that this indication member (13) detected the temperature change during the heating and the history of the structural color change was not preserved.

Here, the observation for the color of the respective indication members in the above Examples and Comparative examples were conducted visually from the front side perpendicular to these indication members.

TABLE 1

| | | | Spherical particles | | | |
|---|---|---|---|---|---|---|
| | Matrix | | | Average | CV | |
| | | Refractive | | particle | value | Refractive |
| | Kind | index | Kind | size (nm) | (%) | index |
| Example 1 | Gelatin/ArG | 1.53 | St/BA/MAA copolymer | 250 | 2.8 | 1.55 |
| Example 2 | Fluorine acrylics | 1.34 | Rutile-type titanium | 120 | 7.1 | 2.76 |
| | | | alkoxide | | | |
| Example 3 | PVA/ArG | 1.50 | PFs | 200 | 5.2 | 1.60 |
| Example 4 | PVA/ArG | 1.51 | Anatase-type | 105 | 6.5 | 2.52 |
| | | | titanium alkoxide | | | |
| Example 5 | Gelatin/ArG/TiO₂ | 1.73 | PMMA | 180 | 3.4 | 1.49 |
| Example 6 | Fluorine acrylics | 1.34 | Melamine | 210 | 5.3 | 1.66 |
| | | | formaldehyde resin | | | |
| Example 7 | Fluorine acrylics | 1.34 | PEs/ferric trioxide | 160 | 8.2 | 2.91 |
| Example 8 | Gelatin/ArG/TiO₂ | 1.72 | Air | 300 | 5.1 | 1.00 |
| Example 9 | Acrylate resin | 1.43 | Melamine | 250 | 5.7 | 1.66 |
| | foaming | | formaldehyde resin | | | |
| Example 10 | Acrylate resin | 1.43 | Anatase-type | 260 | 6.5 | 2.52 |
| | foaming | | titanium alkoxide | | | |
| Example 11 | Polyacrylic acid | 1.43 | PEs/titanium | 165 | 7.2 | 1.75 |
| | sodium | | alkoxide | | | |
| Comparative | Silicone rubber | 1.40 | Polystyrene | 202 | 5.0 | 1.59 |
| example 1 | | | | | | |
| Comparative | Isopropyl amide | 1.51 | Water | 291 | 5.0 | 1.33 |
| example 2 | | | | | | |

| | Layer | | Evaluation result | | | |
|---|---|---|---|---|---|---|
| | spacing | Refractive | Kind of | Color before | Color during | Color after |
| | distance (nm) | index | stimulus | stimulation | stimulation | stimulation |
| Example 1 | 170 | 0.02 | External | Green | Red | Red |
| | | | force | | | |
| Example 2 | 100 | 1.42 | External | Green | Red | Red |
| | | | force | | | |
| Example 3 | 160 | 0.1 | External | Green | Red | Red |
| | | | force | | | |
| Example 4 | 90 | 1.01 | External | Blue | Yellow | Yellow |
| | | | force | | | |
| Example 5 | 150 | −0.24 | External | Blue | Red | Red |
| | | | force | | | |
| Example 6 | 170 | 0.32 | External | Green | Red | Red |
| | | | force | | | |
| Example 7 | 130 | 1.57 | External | Green | Red | Red |
| | | | force | | | |
| Example 8 | 240 | −0.72 | External | Red | Green | Green |
| | | | force | | | |
| Example 9 | 200 | 0.23 | Temperature | Blue | Yellow | Yellow |
| | | | External | Yellow | Green | Green |
| | | | force | | | |
| Example 10 | 210 | 1.09 | Temperature | Green | Red | Red |
| Example 11 | 140 | 0.24 | Humidity | Blue | Red | Red |
| Comparative | 190 | 0.19 | External | Red | Green | Red |
| example 1 | | | force | | | |
| Comparative | 235 | −0.18 | Temperature | Red | Blue | Red |
| example 2 | | | | | | |

The indication members of the present invention can be utilized as, for example, sensors such as a sensor to detect environment change, displays, panels, sheets, labels such as an authorized opening preventing label.

What is claimed is:

1. An indication member comprising:
an indication layer which has an original structural color and is capable of causing a structural color change irreversibly by receiving a stimulus from outside of the indication member so as to exhibit another structural color different from the original structural color.

2. The indication member described in claim 1, wherein the indication layer comprises a matrix and a plurality of spherical particle layers, and wherein each of the plurality of spherical particle layers includes spherical particles having a refractive index different from that of the matrix and the plurality of spherical particle layers are stacked regularly in the thickness direction of the indication layer.

3. The indication member described in claim 2, wherein each of the plurality of spherical particle layers includes the spherical particles and the matrix and the spherical particles are arranged regularly in a two dimensional array in each spherical particle layer.

4. The indication member described in claim 2, wherein a matrix layer composed of only the matrix is provided between spherical particle layers in the plurality of spherical particle layers.

5. The indication member described in claim 1, wherein when the indication layer receives the stimulus from the outside, a layer spacing distance in the plurality of spherical particle layers changes.

6. The indication member described in claim 5, wherein the stimulus from the outside is at least one of an application of an external force, a temperature change and a humidity change.

7. The indication member described in claim 2, wherein the absolute value of a difference in refractive index between the spherical particles and the matrix is 0.02 to 2.0.

8. The indication member described in claim 2, wherein the average particle size of the spherical particles is 50 nm to 500 nm.

9. The indication member described in claim 2, wherein a CV value representing the particle distribution of the spherical particles is 20 or less.

10. The indication member described in claim 2, wherein the thickness of each of the plurality of spherical particle layers is 0.1 to 100 μm.

11. The indication member described in claim 2, wherein the number of stacked layers of the plurality of spherical particle layers is 5 to 500.

12. The indication member described in claim 2, wherein a layer spacing distance in the plurality of spherical particle layers is 50 to 500 nm.

13. The indication member described in claim 2, wherein a structural color is a color represented by the following Formula (1),
λ=2nD(cos θ) Formula (1)
in the formula (1), λ represents the peak wavelength of the structural color, n represents the refractive index of the indication layer represented by the following Formula (2), D represents a layer spacing distance in the plurality of spherical particle layers, and θ represents an observation angle for a vertical line of the indication member,
n=(na·c)+(nb·(1−c)) Formula (2)
in the Formula (2), na represents the refractive index of the spherical particles, nb represents the refractive index of the matrix, and c represents a volume ratio of the spherical particles in the indication layer.

14. The indication member described in claim 1, wherein the indication member is shaped in a sheet.

15. The indication member described in claim 1, wherein the indication layer having the another structural color obtained by the structural color change is capable of causing a further structural color change irreversibly by receiving a stimulus from outside of the indication member so as to exhibit a different structural color other than the original structural color or the another structural color.
